(19) United States
(12) Patent Application Publication
(10) Pub. No.: US 2023/0162236 A1
(43) Pub. Date: May 25, 2023

(54) METHODS, SYSTEMS, APPARATUSES, AND DEVICES FOR FACILITATING A DRIVER TO ADVERTISE PRODUCTS TO PASSENGERS

(71) Applicant: Ahmad Hassan ABU ELREICH, Fresno, CA (US)

(72) Inventor: Ahmad Hassan ABU ELREICH, Fresno, CA (US)

(21) Appl. No.: 17/920,790

(22) PCT Filed: Apr. 23, 2021
(86) PCT No.: PCT/US2021/070451

§ 371 Date: Oct. 23, 2022

Related U.S. Application Data
(60) Provisional application No. 63/014,583, filed on Apr. 23, 2020.

(51) Int. Cl. G06Q 30/0251; G06Q 50/30; G06Q 30/0208; G06Q 30/0601; G06Q 30/0242; G06Q 20/38; H04W 4/23; H04W 4/02

(52) U.S. Cl. CPC G06Q 30/0266; G06Q 50/30; G06Q 30/0208; G06Q 30/0611; G06Q 30/0244; G06Q 20/387; H04W 4/23; H04W 4/02

(57) ABSTRACT

Disclosed herein is a device for facilitating a driver to advertise products to passengers, in accordance with some embodiments. Accordingly, the device may include a presentation device, an input device, a storage device, a monitoring device, a processing device, and a communication device. Further, the presentation device is configured for presenting a product list to the driver and presenting an advertisement of a product to a passenger. Further, the input device is configured for receiving a selection of the product. Further, the storage device is configured for retrieving the advertisement. Further, the monitoring device is configured for generating monitoring data based on monitoring the presenting of the advertisement. Further, the processing device is configured for analyzing the monitoring data and generating a driver reward and a passenger reward. Further, the communication device transmits the driver reward to a driver device and the passenger reward to a passenger device.

### FIELD OF THE INVENTION

Generally, the present disclosure relates to the field of data processing. More specifically, the present disclosure relates to methods, systems, apparatuses, and devices for facilitating a driver to advertise products to passengers.

### BACKGROUND OF THE INVENTION

A software sales tool for vehicle drivers is in demand. Companies can market their products through various advertisement mediums, ranging from television and radio to online and fixed panels and more.

As technology has advanced, people have been increasingly presented with vast amounts of advertising and other information on a daily basis. Consumers are overloaded with information and have thus become desensitized to it. Accordingly, advertisers sometimes struggle to effectively target consumers from a given demographic and thus seek to present advertising in direct and memorable ways so that advertising messages stay with consumers until they purchase the desired goods or services.

Billboards, one common type of advertisement, may be secured to a structure or vehicle and towed around a city or other frequented area, but doing so is generally expensive and ineffective. Accordingly, as the Internet has become part of daily life, online advertising has proliferated, allowing targeted advertising to specific individuals. However, many Internet users are focused on their intended purpose, such as reading and searching for specific information, and thus disregard or ignore advertisements regardless of their relevance. Thus, a system is needed that allows the targeting of specific consumers for direct marketing.

Therefore, there is a need for improved methods, systems, apparatuses, and devices for facilitating a driver to advertise products to passengers that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a device for facilitating a driver to advertise products to passengers, in accordance with some embodiments. Accordingly, the device may include a presentation device, an input device, a storage device, a monitoring device, a processing device, and a communication device. Further, the presentation device may be configured for presenting a product list comprising a plurality of products to the driver. Further, the presentation device may be configured for presenting at least one advertisement of at least one product to at least one passenger. Further, the input device may be configured for receiving a selection of the at least one product from the product list based on the presenting of the product list. Further, the storage device may be communicatively coupled with the input device and the presentation device. Further, the storage device may be configured for retrieving the at least one advertisement of the at least one product based on the selection of the at least one product. Further, the monitoring device may be communicatively coupled with the presentation device. Further, the monitoring device may be configured for generating monitoring data based on monitoring the presenting of the at least one advertisement to the at least one passenger. Further, the processing device may be communicatively coupled with the storage device and the monitoring device. Further, the processing device may be configured for analyzing the monitoring data. Further, the processing device may be configured for generating a driver reward for the driver and a passenger reward for the at least one passenger based on the monitoring data and the at least one advertisement. Further, the communication device may be communicatively coupled with the processing device. Further, the communication device may be configured for transmitting the driver reward to a driver device associated with the driver. Further, the communication device may be configured for transmitting the passenger reward to at least one passenger device associated with the at least one passenger.

Further disclosed herein is a device for facilitating a driver to advertise products to passengers, in accordance with some embodiments. Accordingly, the device may include a presentation device, an input device, a storage device, a monitoring device, a processing device, and a communication device. Further, the presentation device may be configured for presenting a product list comprising a plurality of products to the driver. Further, the presentation device may be configured for presenting at least one advertisement of at least one product to at least one passenger. Further, the input device may be configured for receiving a selection of the at least one product from the product list based on the presenting of the product list. Further, the storage device may be communicatively coupled with the input device and the presentation device. Further, the storage device may be configured for retrieving the at least one advertisement of the at least one product based on the selection of the at least one product. Further, the monitoring device may be communicatively coupled with the presentation device. Further, the monitoring device may be configured for generating monitoring data based on monitoring the presenting of the at least one advertisement to the at least one passenger. Further, the processing device may be communicatively coupled with the storage device and the monitoring device. Further, the processing device may be configured for analyzing the monitoring data. Further, the processing device may be configured for generating a driver reward for the driver and a passenger reward for the at least one passenger based on the monitoring data and the at least one advertisement. Further, the communication device may be communicatively coupled with the processing device. Further, the communication device may be configured for transmitting the driver reward to a driver device associated with the driver. Further, the communication device may be configured for transmitting the passenger reward to at least one passenger device associated with the at least one passenger. Further, the communication device may be configured for receiving the product list from at least one organization device associated with at least one organization. Further, the presenting of the product list may be based on the receiving of the product list.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a device for facilitating a driver to advertise products to passengers, in accordance with some embodiments.

FIG. 3 is a block diagram of the device for facilitating the driver to advertise the products to the passengers, in accordance with some embodiments.

FIG. 4 is a block diagram of the device for facilitating the driver to advertise the products to the passengers, in accordance with some embodiments.

FIG. 5 is a block diagram of the device for facilitating the driver to advertise the products to the passengers, in accordance with some embodiments.

FIG. 6 is a block diagram of a device for facilitating a driver to advertise products to passengers, in accordance with some embodiments.

FIG. 7 is a block diagram of a media system for facilitating a driver to advertise products to passengers, in accordance with some embodiments.

FIG. 8 illustrates a network environment associated with the media system, in accordance with some embodiments.

FIG. 9 is a block diagram of the media system for facilitating the driver to advertise the products to the passengers, in accordance with some embodiments.

FIG. 10 illustrates a driver application associated with the media system, in accordance with some embodiments.

FIG. 11 illustrates a rider application associated with the media system, in accordance with some embodiments

FIG. 12 illustrates a business application associated with the media system, in accordance with some embodiments.

FIG. 13 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating a driver to advertise products to passengers, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

Further, the present disclosure describes methods, systems, apparatuses, and devices for facilitating a driver to advertise products to passengers. Further, the present disclosure provides a new medium for direct sales to vehicle riders (passengers). Drivers themselves (e.g., taxi drivers or any vehicle drivers) can be salespeople. The present disclosure describes helping drivers to use monitor displays and smartphones to make verbal presentations, offer promotions, and administer market surveys.

As the end users, drivers can give riders access to a shopping cart and points or discounts.

The present disclosure describes providing drivers with a website where they can choose companies to promote and products to sell. The website has various features for companies, including registration; display of relevant information, including product and segment information; live video chat; and training webinars.

The website can display products according to area driven in and offers online chat and video chat features for communication between drivers and companies; it shows driver sales information and points and money earned.

Further, the present disclosure describes a media system that comprises a plurality of processors and a plurality of memory units, the latter of which contain instructions that when executed by a processor trigger a user input step and a communication step. The instructions may include routines, programs, objects, data structures, and the like. The media system can be implemented in a network environment, which may comprise one or more servers. The media system can be communicatively connected to the user's computing devices and storage devices. In one embodiment, the media system can provide access to a website that includes a plurality of webpages for display on the user's computing device.

Further, the media system may include a User Input Step. The user input step may include a registration process. In one embodiment, the registration process may include an online registration display (e.g., registration form) that allows a user (e.g., the driver, the rider, or the company selling products) to input registration information such as company information, personal information, vehicle information, and market segment and products on which the user intends to focus.

In some embodiments, the online registration display may be one or more webpages that include a list of products and companies, displayed so that the user can select them by following links or clicking on buttons.

In some embodiments, the registration information can be stored in a storage that can be included in the user computing device or on any server communicatively connected to the user device.

Further, the media system may include a Communication Step. Further, the communication step may include information display and use of a chat module and a webinar module. In one embodiment, the communication step may include one or more webpages. The chat module and webinar module can be configured to facilitate online communication for users via a user interface that can be included on the webpage.

The information display, which can be configured for display on the web, can include user sales information and points and money earned. The chat module can be configured to provide online chat capabilities between the user and his or her selected company (or an operator of the present invention). The chat module may include video chat capability. The webinar module can be configured to facilitate an online meeting or presentation in real time. In one embodiment, the webinar module can include training materials and be configured to provide online training for users. The media system may comprise multiple applications for various types of users. In one embodiment, the media system may include a driver app, a rider app, a business app, a management app, and a controller app, all communicatively connected via a network. The use of multiple applications for different types of users can allow drivers to act as direct sales representatives on behalf of any subscribed business.

Drivers receive training through the media system, and after they make a sales presentation, close a sale, or administer a market survey, both driver and rider get cash points. Drivers can also optionally receive stocks through the media system. Riders can cash out their points or request a ride, with the media system matching them with drivers.

In one embodiment, the driver app can be configured to allow the driver to easily download the app from an app store (e.g., Google Play), register his or her information, and obtain an identification code. The driver app may include various features appropriate in a sales tool used to work for a given business. For example, the driver app may include a driver page that allows the driver to log in and receive a news feed of his or her subscribed companies as well as new companies seeking drivers to subscribe with them. The driver app may also allow drivers to filter the news feed using various methods. The driver app may display icons for each company with which the driver is subscribed. Such icons can be linked to a business training page, as described hereafter. The driver app may also include a search button linked to an Internet search engine, allowing the driver to search for businesses subscribed to the app while filtering by industry, such as restaurants, bars, travel, legal, and so forth.

The driver app further includes a training presentation schedule outlining future online training for drivers. The driver app may also include a map that can give written or verbal notice of, and directions to, any entered address when communicating with a prospective passenger. The driver app may include a video or voice chat module that can be connected with businesses using a business ID code.

The driver app may also include a mechanism for retrieving prize information related to ongoing deals and quotations for riders and rewards. Such prize information can include total rewards earned, total cash earned, available points, and total optional stocks. The driver app may also include driver profile information showing driver experience, qualifications, and interest in particular industries and products. In some embodiments, the driver app may also include rating information for businesses and riders.

The rider app may be configured to provide rider ID codes for riders, allowing them to earn cash points for each presentation. Riders can cash out their own cash points or use them to request free rides. In one embodiment, the rider app may be configured to allow businesses to advertise on the rider app. In other embodiment, the rider app may include features similar to those included in the driver app and may likewise be downloaded from an app store. The business app may be configured in such a way that drivers can subscribe to the business online and be trained on product, presentations, and sales. The business app may also be downloaded by businesses and may allow businesses to buy points to give away to drivers and riders. Businesses such as restaurants and bars can request free rides or advertise free rides to riders via the business app in connection with the rider app and the driver app. The business app may include various features designed to facilitate convenient communications, provide business tools, and facilitate business transactions with riders and drivers.

In some embodiments, the media system may also include other applications such as the management app and the controller app for better operation management of the media system.

The steps and the processes described in connection with the embodiments disclosed herein can be embodied directly in hardware, in a software module executed by a processor, or in a combination of the two. A software module can reside in a memory unit that can include volatile memory, non-volatile memory, and network devices, or other data storage devices now known or later developed for storing information/data. The volatile memory may be any type of volatile memory including, but not limited to, static or dynamic, random access memory (SRAM or DRAM). The non-volatile memory may be any non-volatile memory including, but not limited to, ROM, EPROM, EEPROM, flash memory, and magnetically or optically readable memory or memory devices such as compact discs (CDs) or digital video discs (DVDs), magnetic tape, and hard drives.

The computing device may be a laptop computer, a cellular phone, a personal digital assistant (PDA), a tablet computer, and other mobile devices of the type. Communications between components and/or devices in the systems and methods disclosed herein may be unidirectional or bidirectional electronic communication through a wired or wireless configuration or network. For example, one component or device may be wired or networked wirelessly directly or indirectly, through a third party intermediary, over the Internet, or otherwise with another component or device to enable communication between the components or devices. Examples of wireless communications include, but are not limited to, radio frequency (RF), infrared, Bluetooth, wireless local area network (WLAN) (such as WiFi), or wireless network radio, such as a radio capable of communicating with a wireless communication network such as a Long Term Evolution (LTE) network, WiMAX network, 3G network, 4G network, and other communication networks of the type. In example embodiments, a network can be configured to provide and employ 5G wireless networking features and functionalities.

Further, the present disclosure generally relates to a mobile application. More specifically, the present disclosure relates to a mobile application that allows vehicle drivers to market and sell products.

Further, the present disclosure describes an app for direct sales through rideshare & taxi drive.

Further, the present disclosure describes a system that allows the driver to search for and subscribe to businesses. They can take classes for drivers and businesses can choose the driver that is best suited to promote their business. Businesses also can post in the driver's news feed such as ‘We are looking for drivers who can . . . in this area . . . ’. Riders get cash points or free rides for watching the ad or presentation and a discount if the rider purchase through the app and the drivers get a commission for sales. Drivers can share news feed-people get free rides or cash points for watching the presentation. Bar/restaurants can use the drivers for advertisement. Rider share for sale people require downloading the app, picking the ride, putting info, ads will pop up, discounts will pop up, and selecting a package and a suitable driver will come up. Further, the drivers can initiate the promotion of the product/business and perform sales even if the customer has not installed the app.

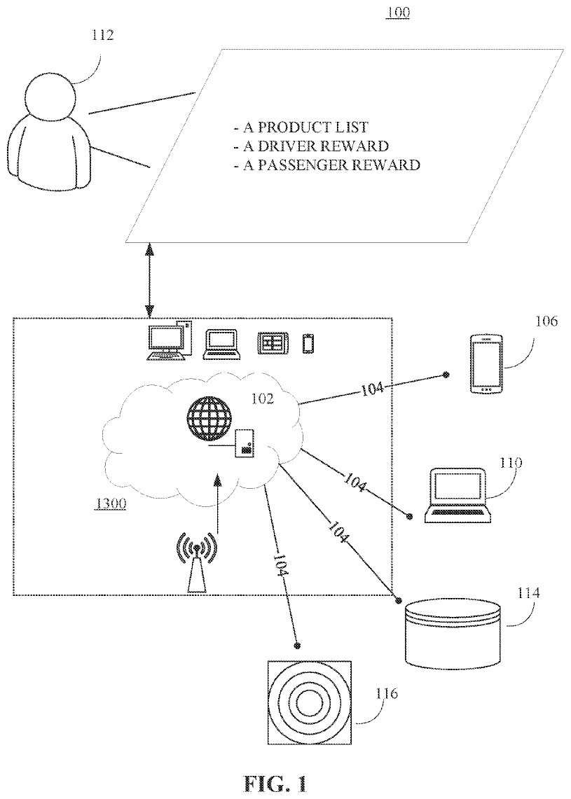

FIG. 1 is an illustration of an online platform 100 consistent with various embodiments of the present disclosure. By way of non-limiting example, the online platform 100 to facilitate a driver to advertise products to passengers may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a web site, a web application, a desktop application, and a mobile application compatible with a computing device 1300.

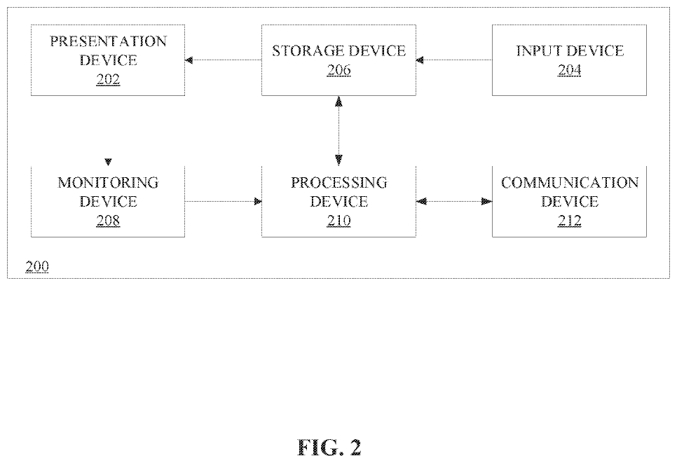

FIG. 2 is a block diagram of a device 200 for facilitating a driver to advertise products to passengers, in accordance with some embodiments. Further, the device 200 may include a presentation device 202, an input device 204, a storage device 206, a monitoring device 208, a processing device 210, and a communication device 212.

Further, the presentation device 202 may be configured for presenting a product list comprising a plurality of products to the driver. Further, the presentation device 202 may be configured for presenting at least one advertisement of at least one product to at least one passenger.

Further, the input device 204 may be configured for receiving a selection of the at least one product from the product list based on the presenting of the product list.

Further, the storage device 206 may be communicatively coupled with the input device 204 and the presentation device 202. Further, the storage device 206 may be configured for retrieving the at least one advertisement of the at least one product based on the selection of the at least one product.

Further, the monitoring device 208 may be communicatively coupled with the presentation device 202. Further, the monitoring device 208 may be configured for generating monitoring data based on monitoring the presenting of the at least one advertisement to the at least one passenger.

Further, the processing device 210 may be communicatively coupled with the storage device 206 and the monitoring device 208. Further, the processing device 210 may be configured for analyzing the monitoring data. Further, the processing device 210 may be configured for generating a driver reward for the driver and a passenger reward for the at least one passenger based on the monitoring data and the at least one advertisement.

Further, the communication device 212 may be communicatively coupled with the processing device 210. Further, the communication device 212 may be configured for transmitting the driver reward to a driver device associated with the driver. Further, the communication device 212 may be configured for transmitting the passenger reward to at least one passenger device associated with the at least one passenger.

Further, in some embodiments, the communication device 212 may be configured for receiving the product list from at least one organization device associated with at least one organization. Further, the at least one organization may include at least one business. Further, the presenting of the product list may be based on the receiving of the product list. Further, in an embodiment, the communication device 212 may be configured for transmitting a request to the at least one organization device. Further, the at least one organization device selects the device 200 from a plurality of devices based on the request. Further, the at least one organization device transmits the product list to the device 200 based on selecting the device 200. Further, the receiving of the product list may be based on the transmitting of the product list.

Further, in some embodiments, the monitoring of the presenting of the at least one advertisement may include detecting an initiating of the presenting of the at least one advertisement and a terminating of the presenting of the at least one advertisement. Further, the generating of the monitoring data may be based on the detecting.

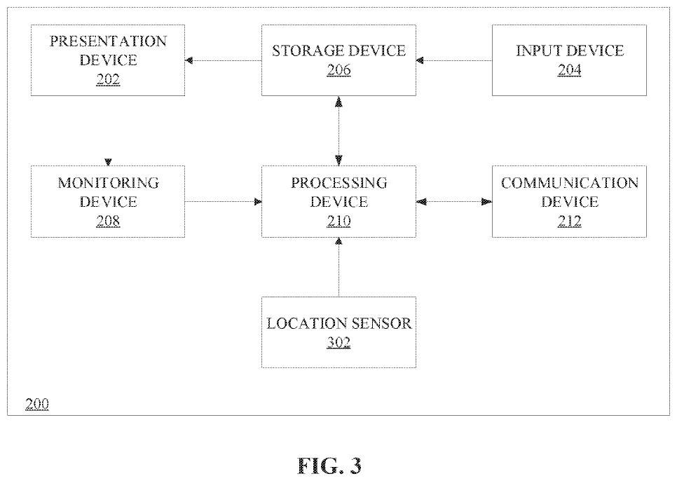

In further embodiments, a location sensor 302, as shown in FIG. 3, may be communicatively coupled with the processing device 210. Further, the location sensor 302 may be configured for generating location data based on a location of the driver and the at least one passenger. Further, the processing device 210 may be configured for analyzing the location data. Further, the processing device 210 may be configured for determining the location of the driver and the at least one passenger based on the analyzing of location data. Further, the processing device 210 may be configured for identifying the plurality of products for the product list based on the determining of the location. Further, the presenting of the product list to the driver may be based on the identifying of the plurality of products. Further, in an embodiment, the generating of the driver reward and the passenger reward may be based on the determining of the location of the driver and the at least one passenger.

Further, in some embodiments, the driver makes verbal presentations of the at least one product to the at least one passenger based on the presenting of the at least one advertisement of the at least one product to the at least one passenger.

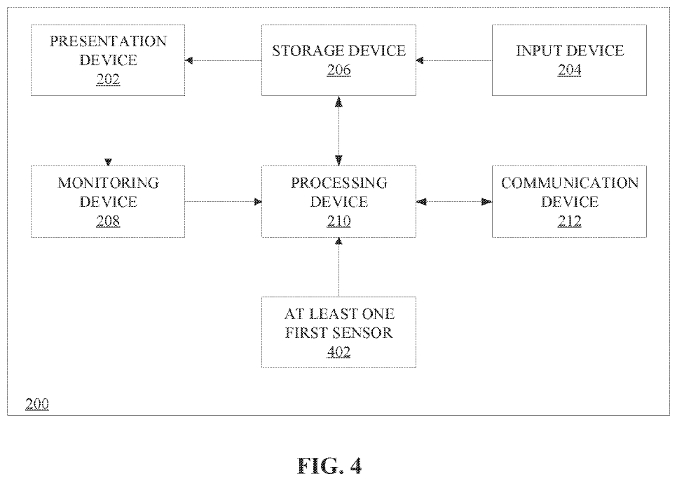

In further embodiments, at least one first sensor 402, as shown in FIG. 4, may be communicatively coupled with the processing device 210. Further, the at least one first sensor 402 may be configured for generating first sensor data based on the verbal presentations made by the driver. Further, the processing device 210 may be configured for analyzing the first sensor data. Further, the processing device 210 may be configured for determining a compliance to at least one guideline associated with the verbal presentations based on the analyzing of the first sensor data. Further, the generating of the driver reward and the passenger reward may be based on the determining of the compliance.

Further, in some embodiments, the communication device 212 may be configured receiving training materials associated with the plurality of products of the product list from at least one external device. Further, the training materials may be configured for providing training to the driver in making verbal presentations of the plurality of products to the at least one passenger.

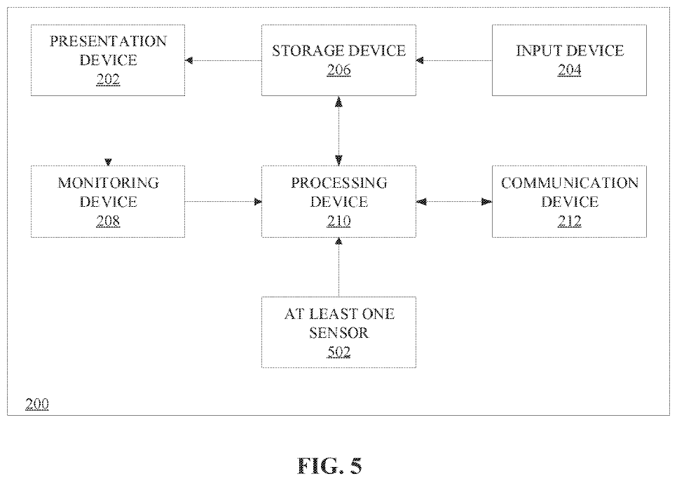

In further embodiments, at least one sensor 502, as shown in FIG. 5, may be communicatively coupled with the processing device 210. Further, the at least one sensor 502 may be configured for generating sensor data based on sensing at least one facial movement of the at least one passenger during the presenting of the at least one advertisement. Further, the processing device 210 may be configured for analyzing the sensor data. Further, the processing device 210 may be configured for determining an attentiveness of the at least one passenger towards the at least one advertisement based on the analyzing of the sensor data. Further, the generating of the driver reward and the passenger reward may be based on the determining of the attentiveness.

Further, in some embodiments, the communication device 212 may be configured for receiving a ride request for a ride from the at least one passenger device. Further, the communication device 212 may be configured for transmitting a ride notification to at least one driver device and the at least one passenger device. Further, the processing device 210 may be configured for analyzing the ride request. Further, the processing device 210 may be configured for identifying at least one driver for providing the ride to the at least one passenger based on the analyzing of the ride request. Further, the processing device 210 may be configured for processing a transaction for the ride using the passenger reward based on the identifying of the at least one driver. Further, the processing device 210 may be configured for generating the ride notification based on the processing.

FIG. 3 is a block diagram of the device 200 for facilitating the driver to advertise the products to the passengers, in accordance with some embodiments.

FIG. 4 is a block diagram of the device 200 for facilitating the driver to advertise the products to the passengers, in accordance with some embodiments. FIG. 5 is a block diagram of the device 200 for facilitating the driver to advertise the products to the passengers, in accordance with some embodiments.

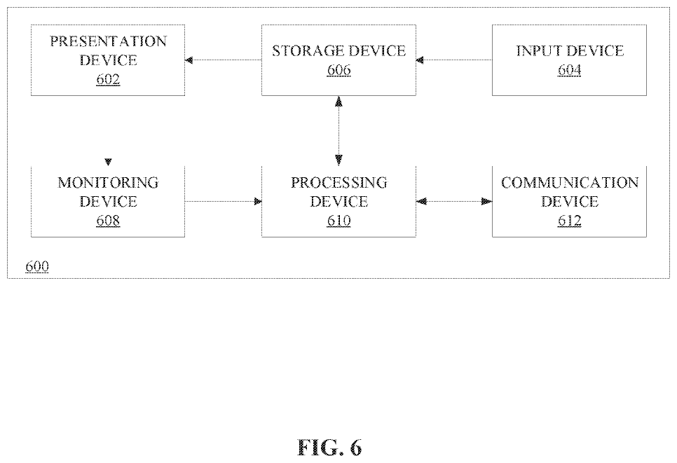

FIG. 6 is a block diagram of a device 600 for facilitating a driver to advertise products to passengers, in accordance with some embodiments. Further, the device 600 may include a presentation device 602, an input device 604, a storage device 606, a monitoring device 608, a processing device 610, and a communication device 612.

Further, the presentation device 602 may be configured for presenting a product list comprising a plurality of products to the driver. Further, the presentation device 602 may be configured for presenting at least one advertisement of at least one product to at least one passenger.

Further, the input device 604 may be configured for receiving a selection of the at least one product from the product list based on the presenting of the product list.

Further, the storage device 606 may be communicatively coupled with the input device 604 and the presentation device 602. Further, the storage device 606 may be configured for retrieving the at least one advertisement of the at least one product based on the selection of the at least one product.

Further, the monitoring device 608 may be communicatively coupled with the presentation device 602. Further, the monitoring device 608 may be configured for generating monitoring data based on monitoring the presenting of the at least one advertisement to the at least one passenger. Further, the processing device 610 may be communicatively coupled with the storage device 606 and the monitoring device 608. Further, the processing device 610 may be configured for analyzing the monitoring data. Further, the processing device 610 may be configured for generating a driver reward for the driver and a passenger reward for the at least one passenger based on the monitoring data and the at least one advertisement.

Further, the communication device 612 may be communicatively coupled with the processing device 610. Further, the communication device 612 may be configured for transmitting the driver reward to a driver device associated with the driver. Further, the communication device 612 may be configured for transmitting the passenger reward to at least one passenger device associated with the at least one passenger. Further, the communication device 612 may be configured for receiving the product list from at least one organization device associated with at least one organization. Further, the presenting of the product list may be based on the receiving of the product list.

Further, in some embodiments, the communication device 612 may be configured for transmitting a request to the at least one organization device. Further, the at least one organization device selects the device 600 from a plurality of devices based on the request. Further, the at least one organization device transmits the product list to the device 600 based on selecting the device 600. Further, the receiving of the product list may be based on the transmitting of the product list.

Further, in some embodiments, the monitoring of the presenting of the at least one advertisement may include detecting an initiating of the presenting of the at least one advertisement and a terminating of the presenting of the at least one advertisement. Further, the generating of the monitoring data may be based on the detecting.

In further embodiments, a location sensor may be communicatively coupled with the processing device 610. Further, the location sensor may be configured for generating location data based on a location of the driver and the at least one passenger. Further, the processing device 610 may be configured for analyzing the location data. Further, the processing device 610 may be configured for determining the location of the driver and the at least one passenger based on the analyzing of location data. Further, the processing device 610 may be configured for identifying the plurality of products for the product list based on the determining of the location. Further, the presenting of the product list to the driver may be based on the identifying of the plurality of products. Further, in an embodiment, the generating of the driver reward and the passenger reward may be based on the determining of the location of the driver and the at least one passenger.

Further, in some embodiments, the driver makes verbal presentations of the at least one product to the at least one passenger based on the presenting of the at least one advertisement of the at least one product to the at least one passenger.

In further embodiments, at least one first sensor may be communicatively coupled with the processing device 610. Further, the at least one first sensor may be configured for generating first sensor data based on the verbal presentations made by the driver. Further, the processing device 610 may be configured for analyzing the first sensor data. Further, the processing device 610 may be configured for determining a compliance to at least one guideline associated with the verbal presentations based on the analyzing of the first sensor data. Further, the generating of the driver reward and the passenger reward may be based on the determining of the compliance.

Further, in some embodiments, the communication device 612 may be configured receiving training materials associated with the plurality of products of the product list from at least one external device. Further, the training materials may be configured for providing training to the driver in making verbal presentations of the plurality of products to the at least one passenger.

In further embodiments, at least one sensor may be communicatively coupled with the processing device 610. Further, the at least one sensor may be configured for generating sensor data based on sensing at least one facial movement of the at least one passenger during the presenting of the at least one advertisement. Further, the processing device 610 may be configured for analyzing the sensor data. Further, the processing device 610 may be configured for determining an attentiveness of the at least one passenger towards the at least one advertisement based on the analyzing of the sensor data. Further, the generating of the driver reward and the passenger reward may be based on the determining of the attentiveness.

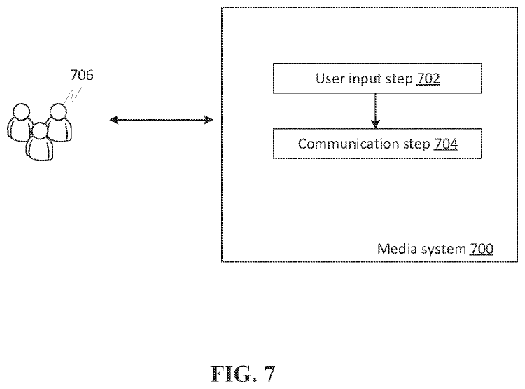

FIG. 7 is a block diagram of a media system 700 for facilitating a driver to advertise products to passengers, in accordance with some embodiments. Further, the media system 700 may include a user input step 702 and a communication step 704. Further, the media system 700 may communicate with at least one user 706. Further, the at least one user 706 may include the driver, the passengers, etc.

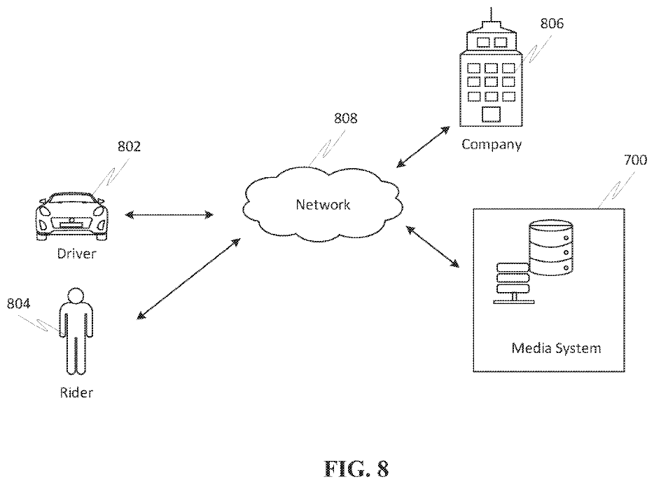

FIG. 8 illustrates a network environment associated with the media system 700, in accordance with some embodiments. Further, the network environment may include a driver 802, a rider 804, a company 806, and the media system 700. Further, the driver 802, the rider 804, the company 806, and the media system 700 may communicate with each other using a network 808.

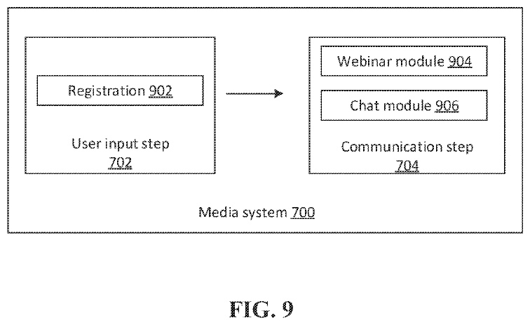

FIG. 9 is a block diagram of the media system 700 for facilitating the driver to advertise the products to the passengers, in accordance with some embodiments. Further, the user input step 702 may include a registration 902. Further, the communication step 704 may include a webinar module 904 and a chat module 906.

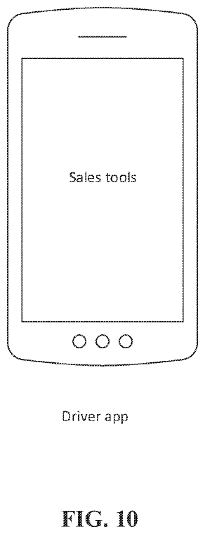

FIG. 10 illustrates a driver application associated with the media system 700, in accordance with some embodiments.

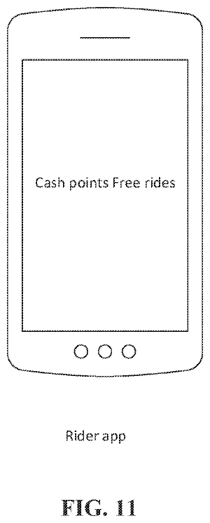

FIG. 11 illustrates a rider application associated with the media system 700, in accordance with some embodiments.

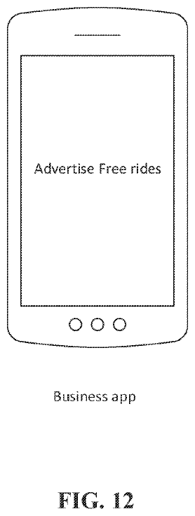

FIG. 12 illustrates a business application associated with the media system 700, in accordance with some embodiments.

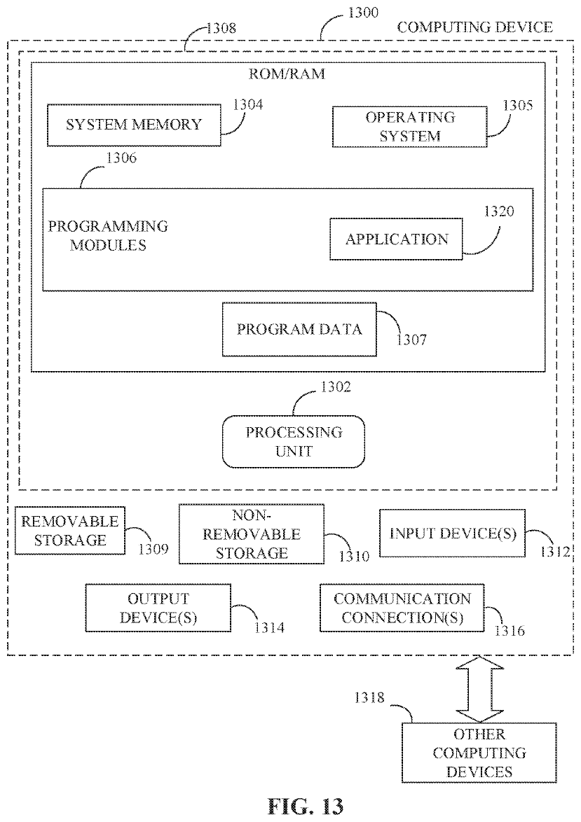

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random-access memory (RAM)), non-volatile (e.g. read-only memory (ROM)), flash memory, or any combination.

System memory 1304 may include operating system 1305, one or more programming modules 1306, and may include a program data 1307. Operating system 1305, for example, may be suitable for controlling computing device 1300's operation. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and non-volatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, a location sensor, a camera, a biometric sensor, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet.

Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1304, including operating system 1305. While executing on processing unit 1302, programming modules 1306 may perform processes including, for example, one or more stages of methods, algorithms, systems, applications, servers, databases as described above. The aforementioned process is an example, and processing unit 1302 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A device for facilitating a driver to advertise products to passengers, the device comprising:
a presentation device configured for:
presenting a product list comprising a plurality of products to the driver; and
presenting at least one advertisement of at least one product to at least one passenger;
an input device configured for receiving a selection of the at least one product from the product list based on the presenting of the product list;
a storage device communicatively coupled with the input device and the presentation device, wherein the storage device is configured for retrieving the at least one advertisement of the at least one product based on the selection of the at least one product;
a monitoring device communicatively coupled with the presentation device, wherein the monitoring device is configured for generating monitoring data based on monitoring the presenting of the at least one advertisement to the at least one passenger;
a processing device communicatively coupled with the storage device and the monitoring device, wherein the processing device is configured for:
analyzing the monitoring data; and
generating a driver reward for the driver and a passenger reward for the at least one passenger based on the monitoring data and the at least one advertisement; and
a communication device communicatively coupled with the processing device, wherein the communication device is configured for:
transmitting the driver reward to a driver device associated with the driver; and
transmitting the passenger reward to at least one passenger device associated with the at least one passenger.

2. The device of claim 1, wherein the communication device is further configured for receiving the product list from at least one organization device associated with at least one organization, wherein the presenting of the product list is based on the receiving of the product list.

3. The device of claim 2, wherein the communication device is further configured for transmitting a request to the at least one organization device, wherein the at least one organization device selects the device from a plurality of devices based on the request, wherein the at least one organization device transmits the product list to the device based on selecting the device, wherein the receiving of the product list is based on the transmitting of the product list.

4. The device of claim 1, wherein the monitoring of the presenting of the at least one advertisement comprises detecting an initiating of the presenting of the at least one advertisement and a terminating of the presenting of the at least one advertisement, wherein the generating of the monitoring data is further based on the detecting. I5

5. The device of claim 1 further comprising a location sensor communicatively coupled with the processing device, wherein the location sensor is configured for generating location data based on a location of the driver and the at least one passenger, wherein the processing device is further configured for:
analyzing the location data;
determining the location of the driver and the at least one passenger based on the analyzing of location data; and
identifying the plurality of products for the product list based on the determining of the location, wherein the presenting of the product list to the driver is based on the identifying of the plurality of products.

6. The device of claim 5, wherein the generating of the driver reward and the passenger reward is further based on the determining of the location of the driver and the at least one passenger.

7. The device of claim 1, wherein the driver makes verbal presentations of the at least one product to the at least one passenger based on the presenting of the at least one advertisement of the at least one product to the at least one passenger.

8. The device of claim 7 further comprising at least one first sensor communicatively coupled with the processing device, wherein the at least one first sensor is configured for generating first sensor data based on the verbal presentations made by the driver, wherein the processing device is further configured for:
analyzing the first sensor data; and
determining a compliance to at least one guideline associated with the verbal presentations based on the analyzing of the first sensor data, wherein the generating of the driver reward and the passenger reward is further based on the determining of the compliance.

9. The device of claim 1, wherein the communication device is further configured receiving training materials associated with the plurality of products of the product list from at least one external device, wherein the training materials are configured for providing training to the driver in making verbal presentations of the plurality of products to the at least one passenger.

10. The device of claim 1 further comprising at least one sensor communicatively coupled with the processing device, wherein the at least one sensor is configured for generating sensor data based on sensing at least one facial movement of the at least one passenger during the presenting of the at least one advertisement, wherein the processing device is further configured for:
analyzing the sensor data; and
determining an attentiveness of the at least one passenger towards the at least one advertisement based on the analyzing of the sensor data, wherein the generating of the driver reward and the passenger reward is further based on the determining of the attentiveness.

11. The device of claim 1, wherein the communication device is further configured for:
receiving a ride request for a ride from the at least one passenger device; and
transmitting a ride notification to at least one driver device and the at least one passenger device, wherein the processing device is further configured for:
analyzing the ride request;
identifying at least one driver for providing the ride to the at least one passenger based on the analyzing of the ride request;
processing a transaction for the ride using the passenger reward based on the identifying of the at least one driver; and
generating the ride notification based on the processing.

12. A device for facilitating a driver to advertise products to passengers, the device comprising:
a presentation device configured for:
presenting a product list comprising a plurality of products to the driver; and
presenting at least one advertisement of at least one product to at least one passenger;
an input device configured for receiving a selection of the at least one product from the product list based on the presenting of the product list;
a storage device communicatively coupled with the input device and the presentation device, wherein the storage device is configured for retrieving the at least one advertisement of the at least one product based on the selection of the at least one product;
a monitoring device communicatively coupled with the presentation device, wherein the monitoring device is configured for generating monitoring data based on monitoring the presenting of the at least one advertisement to the at least one passenger;
a processing device communicatively coupled with the storage device and the monitoring device, wherein the processing device is configured for:
analyzing the monitoring data; and
generating a driver reward for the driver and a passenger reward for the at least one passenger based on the monitoring data and the at least one advertisement; and
a communication device communicatively coupled with the processing device, wherein the communication device is configured for:
transmitting the driver reward to a driver device associated with the driver;
transmitting the passenger reward to at least one passenger device associated with the at least one passenger; and
receiving the product list from at least one organization device associated with at least one organization, wherein the presenting of the product list is based on the receiving of the product list.

13. The device of claim 12, wherein the communication device is further configured for transmitting a request to the at least one organization device, wherein the at least one organization device selects the device from a plurality of devices based on the request, wherein the at least one organization device transmits the product list to the device based on selecting the device, wherein the receiving of the product list is based on the transmitting of the product list.

14. The device of claim 12, wherein the monitoring of the presenting of the at least one advertisement comprises detecting an initiating of the presenting of the at least one advertisement and a terminating of the presenting of the at least one advertisement, wherein the generating of the monitoring data is further based on the detecting.

15. The device of claim 12 further comprising a location sensor communicatively coupled with the processing device, wherein the location sensor is configured for generating location data based on a location of the driver and the at least one passenger, wherein the processing device is further configured for:
analyzing the location data;
determining the location of the driver and the at least one passenger based on the analyzing of location data; and
identifying the plurality of products for the product list based on the determining of the location, wherein the presenting of the product list to the driver is based on the identifying of the plurality of products.

16. The device of claim 15, wherein the generating of the driver reward and the passenger reward is further based on the determining of the location of the driver and the at least one passenger.

17. The device of claim 12, wherein the driver makes verbal presentations of the at least one product to the at least one passenger based on the presenting of the at least one advertisement of the at least one product to the at least one passenger.

18. The device of claim 17 further comprising at least one first sensor communicatively coupled with the processing device, wherein the at least one first sensor is configured for generating first sensor data based on the verbal presentations made by the driver, wherein the processing device is further configured for:
analyzing the first sensor data; and
determining a compliance to at least one guideline associated with the verbal presentations based on the analyzing of the first sensor data, wherein the generating of the driver reward and the passenger reward is further based on the determining of the compliance.

19. The device of claim 12, wherein the communication device is further configured receiving training materials associated with the plurality of products of the product list from at least one external device, wherein the training materials are configured for providing training to the driver in making verbal presentations of the plurality of products to the at least one passenger.

20. The device of claim 12 further comprising at least one sensor communicatively coupled with the processing device, wherein the at least one sensor is configured for generating sensor data based on sensing at least one facial movement of the at least one passenger during the presenting of the at least one advertisement, wherein the processing device is further configured for:
analyzing the sensor data; and
determining an attentiveness of the at least one passenger towards the at least one advertisement based on the analyzing of the sensor data, wherein the generating of the driver reward and the passenger reward is further based on the determining of the attentiveness.
